(19) United States
(12) Patent Application Publication
(10) Pub. No.: US 2025/0138479 A1
(43) Pub. Date: May 1, 2025

(54) DEVICE FOR OPERATING MULTIPLE FUNCTIONS OF A WATCH

(71) Applicant: OMEGA SA, Biel/Bienne (CH)

(72) Inventors: Philippe LOETSCHER, Evilard (CH); Félicien VILLARD, Biel/Bienne (CH)

(73) Assignee: OMEGA SA, Biel/Bienne (CH)

(21) Appl. No.: 18/811,324

(22) Filed: Aug. 21, 2024

(30) Foreign Application Priority Data
Oct. 25, 2023 (EP) 23205761.2

(51) Int. Cl. G04B 3/00; G04B 27/02

(52) U.S. Cl. CPC G04B 3/001; G04B 27/023

(57) ABSTRACT

An operating device (1) for a watch including a control member (2) mounted movably in a support piece (3) of the device (1), the piece (2) being intended to be unmoving relative to the horological movement of the watch, the control member (2) including a gripping element (7), a drive element (8) rigidly connected to the gripping element (7) and a transmission member (31) being rotated by the drive element (8), the transmission member (31) being configured to cooperate with a member for actuating a manual winding mechanism of the device (1), capable of storing mechanical energy, in order to operate a first function of the watch, and with a hand-setting member of the device (1) to control a second function of the watch, and the drive element (8) being configured to cooperate with an operating member (4) to operate third and fourth functions of the watch.

### CROSS REFERENCE TO RELATED APPLICATIONS

This application claims priority to European Patent Application No. 23205761.2 filed Oct. 25, 2023, the entire contents of which are incorporated herein by reference.

### TECHNICAL FIELD OF THE INVENTION

The invention relates to the field of watchmaking, and in particular to devices for operating multiple functions of a watch using a single control member such as a crown.

### TECHNOLOGICAL BACKGROUND

In the prior art, operating devices such as push buttons are known to be fitted to certain watches, in particular watches referred to as having numerous complications, which can include a large number of functions. These push buttons are of various types, including miniature push buttons which are typically embedded in the middle of the watch.

Miniature push buttons of this kind are usually very small, which saves space, particularly in the case of these watches. Moreover, they do not project from the middle and are thus unlikely to be activated unintentionally.

However, one of the drawbacks of such push buttons is that they necessarily require the use of a pointed actuating tool when carrying out operations to operate a watch function, such as setting the time, a date, a moon phase or a day of the month. More specifically, such a use entails a considerable risk of damaging the watch case and thus of altering its aesthetic appearance.

In these circumstances, it is clear that there is a need to find a solution to overcome these drawbacks of the prior art.

### SUMMARY OF THE INVENTION

One of the aims of the invention is to provide an operating device for a watch allowing the functions of this watch to be operated without the need for an actuating tool.

The invention relates to an operating device for a watch comprising a control member mounted movably in a support piece of this device, said piece being intended to be unmoving relative to the horological movement of the watch, said control member comprising a gripping element, a drive element mounted such that it is rigidly connected to said gripping element and a transmission member capable of being rotated by said drive element, said transmission member being configured to cooperate with a member for actuating a manual winding mechanism of the device, capable of storing mechanical energy, in order to operate a first function of the watch, and with a hand-setting member of the device in order to control a second function of the watch, and said drive element being configured to cooperate with an operating member of said device in order to operate third and fourth functions of the watch.

In other embodiments:
the control member is configured to be displaced axially relative to its longitudinal axis between first, second and third control positions for carrying out the first, second, third and fourth functions of the watch;
the control member is placed in a first control position in which a mechanical link is established between one end of the transmission member and the actuating member for transmitting, to said actuating member, a rotational motion of the control member in order to implement the first function of the watch;
the control member is placed in a second control position in which a mechanical link is established between one end of the transmission member and the hand-setting member for transmitting, to said hand-setting member, a rotational motion of the control member in order to implement the second function of the watch;
drive zones of the drive element and of the transmission member respectively are joined together to transmit a rotational motion from the gripping element to the transmission member when the control member is placed in the first and second control positions;
the control member is placed in a third control position in which a mechanical link is established between a free end of the drive element of the control member and a ring movably mounted in a casing ring of the operating member of said device, for transmitting, to said ring, a rotational motion of the control member in order to implement the third or fourth function of the watch;
drive zones of the drive element and of the transmission member respectively are separate from each other to prevent transmission of a rotational motion from the gripping element to the transmission member when the control member is placed in the third control position;
the ring of the control member is configured to actuate mechanisms of a horological movement of the watch implementing said third and fourth functions;
the casing ring comprises, on its inner peripheral wall, a cooperation zone for cooperation between the ring and the free end of the drive element, said zone comprising stop elements defining a course of travel of this ring mounted movably in the casing ring;
the casing ring comprises a through-hole connecting together inner and outer peripheral walls of said casing ring, the hole including a zone for passing an actuating part of the drive element;
the passage zone comprises a central part configured for the arrangement of a main portion of an actuating part of the drive element in said hole and an eccentric part forming a passage allowing a coupling element of this actuating part to pass through the body of said casing ring;
the ring comprises an element for actuating a pivoting element of the control member configured to actuate the mechanism implementing the third or fourth function of the watch;
the control member comprises a first resilient return element configured to automatically return the ring to a rest position;
the first control position is between the second and third positions;
the drive zone is formed on an inner surface of the drive element and the drive zone is formed on an outer surface of the transmission member.

The invention further relates to a watch comprising such an operating device.

### BRIEF DESCRIPTION OF THE FIGURES

Other features and advantages of the invention will be better understood upon reading the following description given of a non-limiting specific embodiment of the invention, provided for illustration purposes with reference to the accompanying figures, in which:

FIGS. 1 to 3 show different views of the device for operating multiple functions of a watch, which device is formed by a control member and at least one functional member such as an operating member, according to one embodiment of the invention;

FIG. 4 shows a view of the control member of this operating device arranged in a first axial position for controlling a first function of the watch, according to the embodiment of the invention;

FIG. 5 shows a view of the control member of this operating device arranged in a second axial position for controlling a second function of the watch, according to the embodiment of the invention;

FIG. 6 shows a view of the control member of this operating device arranged in a third axial position for controlling a third function of the watch, according to the embodiment of the invention;

FIG. 7 shows a view of the control member of this operating device arranged in the third axial position for controlling a fourth function of the watch, according to the embodiment of the invention;

FIGS. 8a and 8b show views of a portion of an outer peripheral wall of a casing ring of the operating member of the operating device, said portion comprising a through-hole having at least one zone for passing a free end of a drive element of the control member for operating the third and fourth functions of the watch, according to the embodiment of the invention;

FIG. 9 shows a view of the portion of the outer peripheral wall of the casing ring when the free end of the rotary drive element is inserted in the corresponding passage zone of the through-hole for operating the third and fourth functions of the watch, according to the embodiment of the invention;

FIG. 10 shows a view of the control member placed in the third axial control position after this control member has been rotated to operate the third function, according to the embodiment of the invention; and

FIG. 11 shows a view of the control member placed in the third axial control position after this control member has been rotated to operate the fourth function, according to the embodiment of the invention.

### DETAILED DESCRIPTION OF THE INVENTION

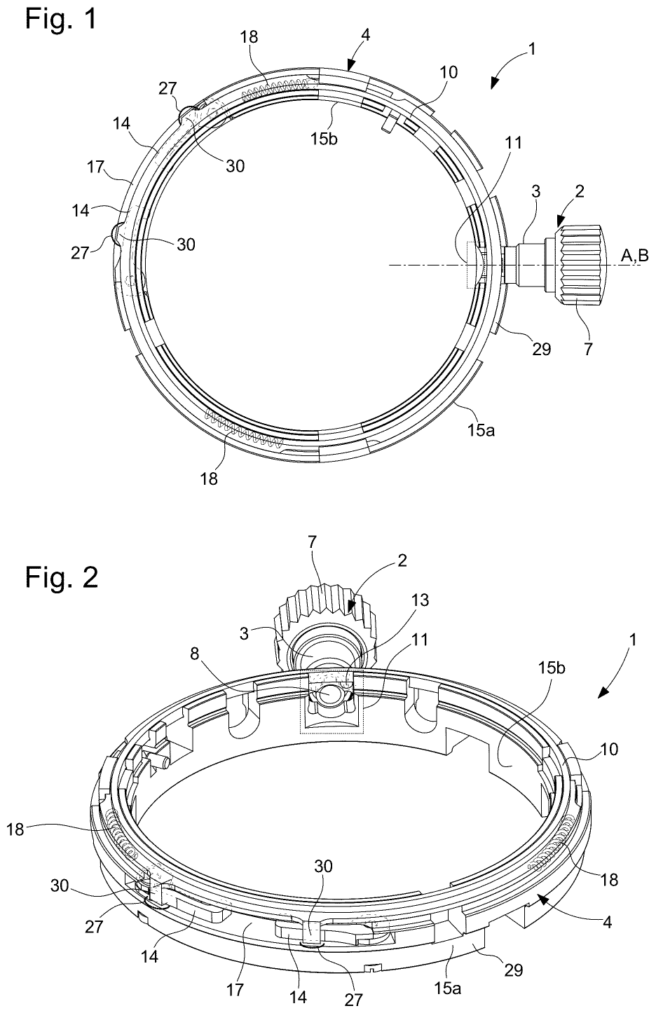

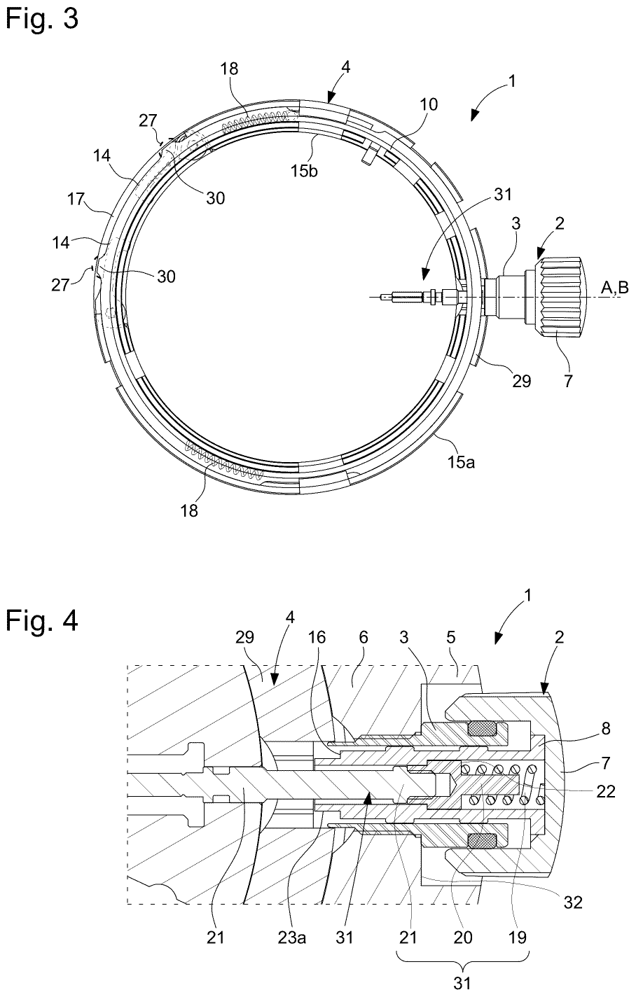

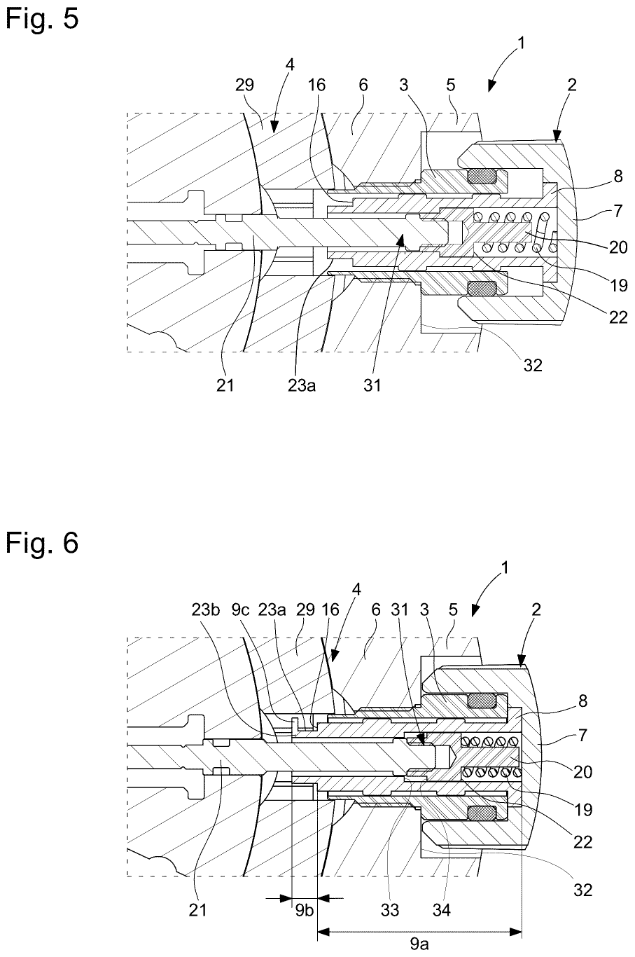

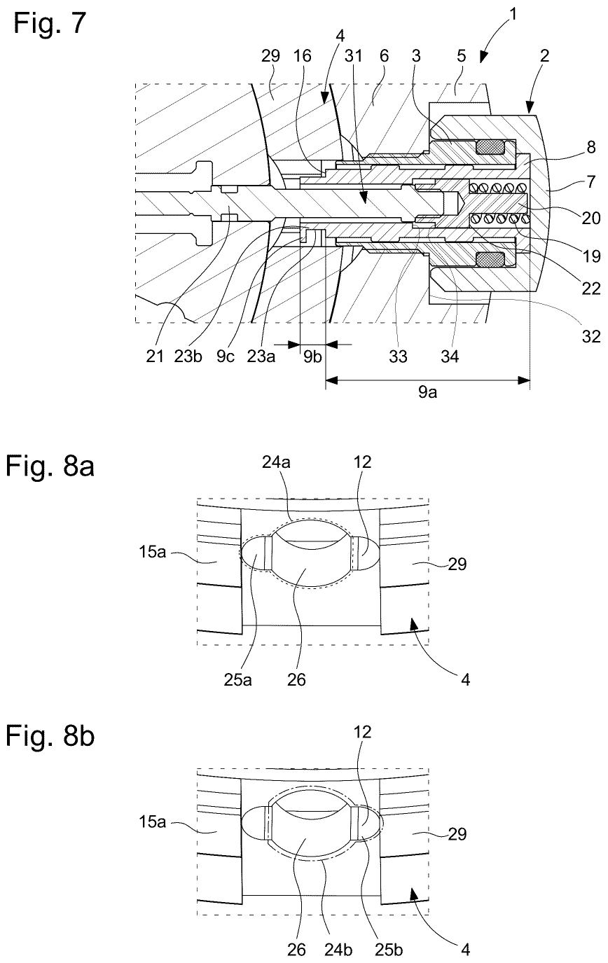

With reference to FIGS. 1 to 11, the present invention relates to a watch, also referred to as a timepiece, such as a wristwatch including a device 1 for operating multiple functions which are implemented by a horological movement included in this watch. In the present embodiment, this control device 1 is configured to implement four functions, namely first, second, third and fourth functions, as will be seen in the remainder of this description.

Such a watch typically includes a case 5 formed by a middle 6, which is preferably circular in shape, defining a central internal recess intended to receive the horological movement, the external contour of which matches the internal shape of a casing ring 29. This watch can be fitted with screws or clamps to hold the movement in this casing ring 29 as well as to hold this casing ring 29 in the middle 6 of the watch case 5.

Such a horological movement can be a mechanical or quartz movement. As seen above, this movement is configured to implement horological functions and, in the present embodiment, four horological functions. These functions are controlled from the operating device 1 for the purposes of adjusting, correcting or activating mechanisms of this movement. It should be noted that such functions are preferably operated independently of one another by a user using this operating device 1 of the watch. In this context, this device 1 can be considered to be an operating device 1 for operating a mechanism of the movement, implementing a function of the watch.

It is understood that this movement is adapted to perform the functions, in particular by means of separate mechanisms and/or separate functional members of the movement, which can be kinematically linked together. By way of example, each mechanism or member can in practice lead to a separate display on the watch, such as, for example, the display of the current time on the one hand and a date or a moon phase on the other. This mechanism or member can further comprise a manual winding mechanism capable of storing mechanical energy. The movement and its functions are operated and/or controlled via the operating device 1.

To this end, this device 1 for operating functions of the movement comprises:
a support piece 3;
a control member 2, such as a push button with a rotating head or a crown or a crown with a push button, a winding button or any crown allowing the horological movement to be operated; and
functional members such as an operating member 4, a hand-setting member and an actuating member for a manual winding mechanism.

In this device 1, the support piece 3, which can also be referred to as the “support and guide piece”, is preferably a tube provided with a through-opening which is configured to provide sliding guidance. This tube is intended to be fixedly engaged in a through-orifice extending radially in the middle 6 of the watch. Thus, in this configuration, this piece 3 is arranged such that it is unmoving relative to the horological movement.

The control member 2 is movably mounted in this opening in the support piece 3. Such a control member 2 is intended to be engaged through the middle 6 of the case 5 of this watch by means of the support piece 3. This control member 2 includes a gripping element 7 and a rotary drive element 8 which is formed by a tubular extension rigidly connected to this gripping element 7, as well as a transmission member 31 forming one end of this control member 2. In this control member 2 and as will be seen below, this transmission member 31 is rotated by said drive element 8 when the gripping element 7 is actuated to perform such a rotational motion. It should be noted that in this configuration, the gripping element 7 can be, for example, a crown head when the control member is a crown.

In this control member 2, the drive element 8 is arranged essentially in the support piece 3 and is also configured to be moved or even slid in the opening provided in this piece 3. More specifically, the drive element 8 comprises a hollow body made up of two parts, namely: a fastening part 9a by means of which this element 8 is connected to the gripping element 7 of the control member 2 and an actuating part 9b of the operating member 4, this actuating part 9b comprising the end of this drive element 8. This actuating part 9b is capable of participating in the operation of the third and fourth functions of the horological movement by way of a coupling element 9c with which it is provided. In the body of this drive element 8, the actuating part 9b is arranged successively to the fastening part 9a. These two parts 9a, 9b are moreover connected to each other by a shoulder 16 formed on the outer surface of the body of this drive element 8, as can be seen in FIGS. 4 to 7. The actuating part 9b consists of a main portion 23a and a terminal portion 23b, the terminal portion 23b comprising the coupling element 9c referred to above. In this configuration, the main portion 23a is between the shoulder 16 and the terminal portion 23b.

In this drive element 8, the coupling element 9c extends perpendicularly to an outer surface of the actuating part 9b. More particularly, this coupling element 9c extends substantially perpendicular to a zone of this surface included in the terminal portion 23b of this actuating part 9b. In other words, this coupling element 9c extends substantially perpendicularly to the longitudinal axis A of the control member 2.

As mentioned above, the actuating part 9b, formed by the main and terminal portions 23a, constitutes the end of the drive element 8. It can thus be specified that the coupling element 9c of this actuating part 9b extends substantially perpendicularly to the surface of this end.

Moreover, the fastening part 9a of the drive element 8 can be driven into the gripping element 7 of the control member 2 or be made in one piece therewith. As mentioned above, this drive element 8 comprises a shoulder, given the reference numeral 16 in FIGS. 4 to 7, which connects the fastening and actuating parts 9a, 9b together. Such a shoulder 16 preferably has a flat surface. It should be noted that such a surface is also substantially perpendicular to the longitudinal axis A of the control member 2.

Furthermore, this drive element 8 further comprises a drive zone 33 which is formed in its inner surface. More specifically, this drive zone 33 is formed in a portion of the inner surface located in the fastening part 9a of this drive element 8. This drive zone 33 comprises a contact face which is substantially perpendicular to the longitudinal axis A.

As mentioned above, the control member 2 further comprises the member 31 for transmitting a rotational motion to at least one functional member of the operating device 1. This transmission member 31 comprises a spring 19 which is mounted free in the hollow body of the drive element 8 and in particular in a cylindrical recess defined in the fastening part 9a of this drive element 8 fastened to the gripping element 7 of the control member 2. This transmission member 31 further comprises a compression piece 20 compressing this spring 19, which compression piece bears on a rod 21, the end of which forms one end of this transmission member 31 but also that of the control member 2. This compression piece 20 comprises a shoulder 22 forming a bearing zone for a first end of the spring 19, the shoulder 22 being located facing the gripping element 7 of the control member, which element 7 thus comprises the other bearing zone capable of cooperating with the second end of this spring 19.

This transmission member 31 comprises a drive zone 34 which is formed in its outer surface. This drive zone 34 comprises a contact face which is substantially perpendicular to the longitudinal axis A.

It should be noted that the drive zones 33, 34 of the drive element 8 and of the transmission member 31, in particular the contact faces thereof, are arranged facing each other in the control member 2. Moreover, these drive zones 33, 34, in particular the contact faces thereof, are configured to cooperate with each other in frictional contact so as to transmit the rotational motion of the gripping element 7 to the transmission member 31 via the drive element 8.

Such a transmission member 31 is configured in particular to:
communicate/transmit a rotational motion applied to the gripping element 7 of the control member 2 by coupling to:
   the actuating member of the manual winding mechanism when the first function of the watch is implemented;
   the hand-setting member to operate the second function of the watch;
improve cooperation between the coupling element 9c of the actuating part 9b and a coupling element 13 of the operating member 4, in order to ensure optimum displacement of a ring 10 of this member 4, as will be explained below.

As mentioned above, the operating device 1 is able to implement a plurality of functions of the movement depending on different axial positions of the control member 2 relative to the movement or to an outer surface 32 of the middle 6 of this watch and further depending on the direction of rotation of this control member 2 in the selected axial position.

More specifically, the control member 2 of this device 1 is mounted so as to be movable in the support piece 3 by being actuated rotatably, and by being pulled away from or pushed towards its longitudinal axis A, relative to this support piece 3. In fact, this control member 2 is configured to be displaced axially relative to its longitudinal axis A between first, second and third axial control positions for carrying out the first, second, third and fourth functions of the watch.

More specifically, when this control member 2 is placed in the first control position in order to operate the first function of this watch, the end thereof is then mechanically connected to the actuating member. This end of the control member 2 is formed by a coupling end of the rod 21 of the transmission member 31 of this control member 2. It is thus understood that in this configuration, such an end is coupled to the actuating member in order to transmit, to this said actuating member, a rotational motion of the control member 2 and in particular of its gripping element 7.

In this context, this first control position can also be referred to as the winding position. It should be noted that such a first position can also be referred to as the neutral axial position or initial axial position because it can be the default or rest or initial position of the control member 2.

In such a case, this first control position is preferably between the second and third axial control positions. In other words, to place the control member 2 in:
the second control position, starting from the first position, this control member 2 is thus displaced axially along the longitudinal axis A of this first control position in a direction opposite to that directed towards the movement or the outer surface 32 of the middle 6 of the watch, i.e. in a direction working to move the control member 2 away from the movement or from the outer surface 32 of the middle 6 of the watch;
the third control position, starting from the first position, this control member 2 is thus displaced axially along the longitudinal axis A of this first control position in a direction towards the movement or the outer surface 32 of the middle 6 of the watch.

When this control member 2 is placed in the second control position in order to operate the second function of this watch, the end thereof is then mechanically connected to the hand-setting member. In this configuration, this end of the control member 2, in this case the coupling end of the rod 21, is coupled to the hand-setting member to transmit a rotational motion of the control member 2 to said hand-setting member.

It should be noted that in this configuration where the control member 2 is placed in the first and second control positions, the drive zones 33, 34 of the drive element 8 and of the transmission member 31 respectively are joined together to transmit a rotational motion from the gripping element 7 to the transmission member 31.

Finally, when this control member 2 is placed in the third control position, a mechanical link is then established between the actuating part 9b of the drive element 8 and the ring 10 of the operating member 4, to transmit, to this said ring 10, a rotational motion of this control member 2 in order to implement said third or fourth function of the watch. In this configuration, the drive zones 33, 34 are separate, i.e. they are no longer in contact so that the rotational motion of the gripping element 7 is not transmitted to the first drive element 31.

In this context, it is understood that the drive element 8 is able to cooperate with the operating member 4. Such a member 4 is preferably configured to be connected to the horological movement, in particular when a mechanism of this movement is activated to perform the third and fourth functions of the watch. For this purpose, this member 4 comprises the casing ring 29, the ring 10, at least one first resilient return element 18 and at least one movable actuating element 30.

In this member 4, the casing ring 29, also referred to as the encasing ring, can have various shapes insofar as it surrounds the horological movement and is placed inside the middle 6 of the case 5. In the present embodiment, this casing ring 29 is preferably substantially circular in shape. Such a casing ring 29 comprises upper and lower faces as well as inner and outer peripheral walls 15a, 15b connecting these two faces together.

In this configuration, the upper face of the casing ring 29 comprises a support zone intended to accommodate or receive the ring 10 as part of its arrangement in this casing ring 29. This support zone comprises a flat surface, the lateral edges of which are wholly or partially raised over the entire length of this zone, in order to ensure that the ring 10 is held and guided on this surface, in particular when this ring 10 is displaced. Such a surface of the support zone further comprises an open recess configured to receive each first resilient return element 18 of this member 4. In this configuration, the first resilient return element 18, which can be a helical spring, is thus arranged below the ring 10. As will be seen below, the first resilient return element 18 is intended to automatically return the ring 10 to its rest position after it has been biased for the operation of the third and fourth functions of the watch.

The casing ring 29 of this member 4 further comprises a through-hole 12 connecting its inner and outer peripheral walls 15a, 15b to each other. Such a hole 12 has a central axis B which is coincident with the longitudinal axis A of the control member 2. In this configuration, the geometry of this hole 12 and its location in the casing ring 29 are defined such that the drive element 8 can pass therethrough. This hole 12 comprises at least one zone 24a, 24b for passing the free end of the drive element 8 in order to operate the third and fourth functions of said watch.

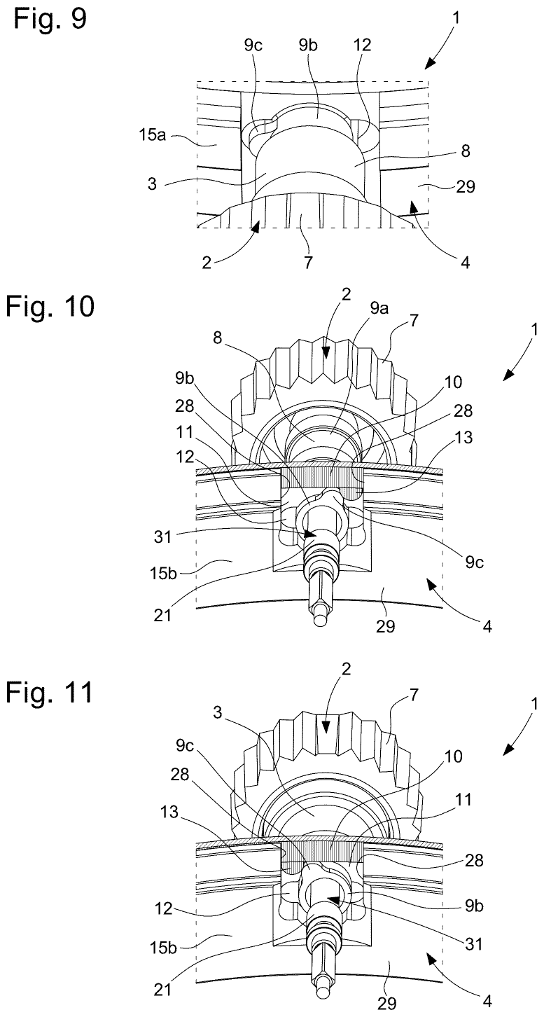

With reference to FIGS. 8a, 8b and 9, this hole 12 includes first and second passage zones 24a, 24b each configured to operate the third and fourth functions of the watch. In other words, these two passage zones 24a, 24b make it possible to structurally configure such a through-hole 12 in order to operate the third and fourth functions of the watch. In this context, each passage zone 24a, 24b comprises a central part 26 configured for the arrangement of the main portion 23a of the actuating part 9b in the through-hole 12, and an eccentric part 25a, 25b configured for the passage of the coupling element 9c in this hole 12. This eccentric part 25a, 25b forms a passage allowing the coupling element 9c to pass through the body of said casing ring 29 as far as a cooperation zone 11 defined in the inner peripheral wall 15b which will be discussed below. It is understood in this context that the two passage zones 24a, 24b share the same central part 26. In other words, the central parts 26 of these two zones 24a, 24b are coincident. In this configuration, the central part 26 extends over a distance from the outer peripheral wall 15a to the inner peripheral wall 15b of the casing ring 29, this distance being substantially shorter than the length of the main portion 23a of the actuating part 9b. A “substantially shorter” distance is understood to mean that this distance is “strictly shorter” or “appreciably shorter” than the length of the main portion 23a.

The casing ring 29 further comprises a through-opening 17 forming a recess for receiving at least one pivoting element 14 such as a lever, capable of being actuated by the ring 10 in order to interact with the mechanism of the movement implementing the third or fourth function. This casing ring 29 comprises a second resilient return element and a retaining element which are disposed in this recess and which are intended to cooperate with the pivoting element 14 in order, in particular, to place it in an initial rest position. This pivoting element 14 thus alternates between the initial position and an activation position in which part of this element 14 projects from the inner peripheral wall 15b of the casing ring 29 in order to interact with the mechanism implementing the third or fourth function to be operated. The arrangement of this pivoting element 14 in the activation position is controlled by the ring 10 and in particular by an actuating element 30 of this ring 10. It should be noted that this pivoting element 14 moves from the activation position to the initial position under the action of the second resilient return element, which causes this pivoting element 14 to move in a direction opposite to that intended to bring it to its activation position, until this element 14 comes into abutment against the retaining element.

As mentioned above, the casing ring 29 comprises a cooperation zone 11 for cooperation between the rotary drive element 8 and the operating member 4. More specifically, this zone 11 is where the coupling element 9c of the actuating part 9b cooperates with a coupling element 13 of the ring 10 in order to cause this ring 10 to move in the casing ring 29. Such a zone 11 is included on the inner peripheral wall 15b of the casing ring 29. In particular, this zone 11 comprises a portion of this peripheral wall 15b into which the through-hole 12 opens. In this configuration, the zone 11 includes stop elements 28 capable of cooperating with the coupling element 13 of the ring 10 so as to define the course of travel of this ring 10 which is movable in the casing ring 29.

In this device 1, the ring 10, otherwise referred to as the “movable ring”, has a shape that is configured to ensure its arrangement and movement in the support zone of the casing ring 29. In the present embodiment, this ring 10 has a shape that is substantially circular. This ring 10 comprises upper and lower faces and inner and outer lateral faces.

As mentioned above, the ring 10 comprises said at least one actuating element 30, the coupling element 13, and at least one element for connection to the first resilient return element 18. This ring 10 includes as many actuating and connecting elements 30 as there are functions to be operated. In the present embodiment, this ring 10 comprises two actuating elements 30, a single coupling element 13 and two connecting elements capable of cooperating with two different first resilient return elements 18, as illustrated in FIGS. 1 to 3, in order to operate or control the third and fourth functions.

In this ring 10, this actuating element 30 of the pivoting element 14 is included on the outer lateral face of the ring 10. This actuating element 30 is configured to extend towards a region 27 of the recess receiving the pivoting element 14, said region being located in the vicinity of this pivoting element 14 to be actuated. In other words, this actuating element 30 extends substantially vertically towards this region 27 and opposite the pivoting element 14. It is understood that the location of the actuating element 30 in this region 27 of the recess allows this actuating element 30 to be arranged in the immediate vicinity of the pivoting element 14. Such an arrangement allows this pivoting element 14 to be activated by this actuating element 30 so that it moves from its initial position to its activation position. This actuating element 30 projecting from the outer lateral face of the ring 10 has a shape substantially similar to that of the letter “L” by being formed of a first portion which is substantially perpendicular to this face and a second portion which is substantially parallel to this same face, said portions being substantially perpendicular to each other.

This ring 10 further comprises an element for connection to the first resilient return element 18 arranged in a recess included in the support zone of the casing ring 29. This connection element is included on the lower face of this ring 10. This element extends substantially perpendicularly from this lower face towards the bottom of the corresponding recess comprising this first resilient return element. In other words, this connecting element is partly arranged in this recess of the support zone, between a first end of the first resilient return element 18 and a wall of this recess. This connecting element has a shape that is configured to apply or exert a stressing force on this first end with which it is in contact, the second end of this first return element 18 being able to bear against or be supported by a support wall of this recess that is arranged opposite this connecting element. It is understood that in this configuration, the connecting element being partly located in the recess is thus able to be moved within the enclosure of this recess to compress this return element 18 when the ring 10 is moving.

With reference to FIGS. 2, 10 and 11, the coupling element 13 of the ring 10 is included on the inner lateral face of this ring 10. This element 13, which is preferably made in one piece with the body of the ring 10, forms a raised portion on this face which is essentially polygonal in shape. This shape is particularly suitable for achieving optimum coupling with the coupling element 9c of the actuating part 9b.

As mentioned above, the device 1 further comprises the transmission member 31 which is configured to improve cooperation between the coupling element 9c and the coupling element 13, in order to ensure optimum displacement of the ring 10 in the support zone of the casing ring 29. More specifically, such a transmission member 31 helps to ensure that the contact established between the coupling element 9c and the inner lateral face of the ring 10 and thus the surface of the cooperation zone 11 is maintained in order to guarantee that the coupling between this coupling element 9c and the coupling element 13 is achieved for the displacement of the ring 10 in the casing ring 29.

Thus, to summarise, when this control member 2 is placed in the third control position for operating the third function, the end of the drive element 8 is thus inserted into the opening 24a visible in FIG. 8a. In this configuration, the control member 2 is thus set in motion in a direction of rotation intended to operate this third function of this watch. During this rotational motion, the coupling element 9c of the drive element 8 cooperates with the coupling element 13 of the ring 10 in order to displace this ring 10. In this context, such a displacement of this ring 10 will then cause the actuation of the pivoting element 14 which will thus interact with the mechanism of the movement implementing this third function.

Similarly, when this control member 2 is placed in the third control position for operating the fourth function, the end of the drive element 8 is thus inserted into the other opening 24b visible in FIG. 8b. In this configuration, the control member 2 is thus set in motion in a direction of rotation intended to operate this fourth function of the watch. This direction of rotation is the opposite of that used to operate the third function. During this rotational motion, the coupling element 9c of the drive element 8 cooperates with the coupling element 13 of the ring 10 in order to displace this ring 10. In this context, such a displacement of this ring 10 will then cause the actuation of the corresponding pivoting element 14 which will thus interact with the mechanism of the movement implementing this fourth function.

In this embodiment, it is understood that such an operating device 1 makes it possible to implement a method for operating the watch and in particular for operating multiple functions of the watch, in particular four functions of this watch.

For this purpose, this method provides for a process of activating this device 1 to operate the first, second, third or fourth function of the watch. During this process, the control member 2 is manipulated to place the control member 2 in the axial control position corresponding to the function to be operated, namely:
the first axial control position for the first function, in which first position the drive zones 33, 34 are joined together to take part in the transmission of a rotational motion from the gripping element 7 to the transmission member 31;
the second axial control position for the second function, in which second position the drive zones 33, 34 are joined together to take part in the transmission of a rotational motion from the gripping element 7 to the transmission member 31;
the third axial control position for the third or fourth function, in which third position the drive zones 33, 34 are separated from each other to prevent/prohibit/deactivate the transmission of a rotational motion from the gripping element 7 to the transmission member 31.

Manipulating the control member 2 makes it possible to move from one control position to another in order to select one of the functions of the watch. It should be noted that in the present embodiment, the control member 2 is initially placed in the first axial control position, which corresponds to the manual winding function.

As mentioned above, when the control member 2 is manipulated to be arranged in the first and second control positions, the end of this member 2 is then coupled to the actuating member of the manual winding mechanism and the hand-setting member respectively. Once the manual winding function has been completed, this method can include a process of deactivating the device 1 during which the control member 2 remains placed in this first control position. In the case of the hand-setting function, the process of deactivating the device 1 of this method can provide for the control member 2 to be pushed axially towards the outer surface 32 of the middle 6, or of the movement, as it passes from the second control position to the first position.

When the control member 2 is manipulated to move from the first or second control position to the third control position, the gripping element 7 is thus arranged as close as possible to the outer surface 32 of the middle 6. During this manipulation, the control member 2 is displaced axially towards the through-hole 12, by compressing the spring 19 arranged between the gripping element 7 of the control member 2 and the compression piece 20 included in this control member 2. When the actuating part 9b of the drive element 8 of this control member 2 is located close to or in contact with the outer peripheral wall 15a of the casing ring 29 of the control member 4, the control member 2 is thus manipulated rotatably to insert this actuating part 9b into at least one passage zone 24a, 24b of the through-hole 12. As mentioned above, in the present embodiment, the through-hole 12 can comprise two passage zones 24a, 24b, intended for operating the third and fourth different functions of the watch. In this context, the control member 2 is thus rotated in a first direction in order to select the passage zone 24a, 24b relating to the third or fourth function to be operated and to insert this actuating part 9b therein until the shoulder 16 of the drive element 8 comes into abutment against the outer peripheral wall 15a of the casing ring 29. Once this shoulder 16 is in abutment against the outer peripheral wall 15a, the control member 2 is then manipulated in a second direction opposite/contrary to the first direction, to be placed in the third control position in order to cooperate with the coupling element 13 of the ring 10. In this latter configuration, the coupling element 9c of the actuating part 9b can thus cooperate with the coupling element 13 of the ring 10. It should be noted that in this third control position, the coupling element 9c is held in abutment on the inner peripheral wall 15b of the casing ring 29 under the action of the spring 19 which exerts a resilient return force on the control member 2. It should be noted that the third control position is that in which the actuating part 9b of the drive element 8 of the control member 2 is engaged in the through-hole 12 and/or in which this part 9b cooperates with or is coupled to the ring 10. In other words, the third control position is that in which the main portion 23a of this actuating part 9b is arranged in the through-hole 12.

Subsequently, manipulation of the control member 2 in the second direction of rotation generates a displacement of the ring 10 in the support zone of the casing ring 29 as a result of the cooperation between the coupling element 9c and the coupling element 13 of the ring 10. This displacement continues until the coupling element 13 is in contact with the corresponding stop element 28 of the cooperation zone 11. This displacement of the ring 10 causes the first resilient return element 18, arranged in the recess defined in the support zone below this ring 10, to be stressed by means of its connection element. During this displacement, the actuating element 30 of the ring 10 actuates the corresponding pivoting element 14, causing the position of this pivoting element 14 to change and move into an activation position in which part of this element 14 projects from the inner peripheral wall 15b of the casing ring 29 in order to interact with the corresponding mechanism of the movement to implement the third or fourth operated function.

Subsequently, once the manipulation of the control member 2 has been completed, the ring 10 is automatically placed in its rest position under the action of the first resilient return element 18 which then recovers its rest shape. Placing the ring 10 in its rest position automatically places the pivoting element 14 in its initial position, as it is no longer stressed by the actuating element 30 of the ring 10.

Subsequently, the method can comprise a process of deactivating the device 1 during which the control member 2 is manipulated by passing from the third control position to the first position. In this context, the control member 2 is thus rotated in the first direction until the coupling element 9c is positioned facing the eccentric part 25a, 25b of the corresponding passage zone 24a, 24b of the through-hole 12 of the casing ring 29. In such a configuration, the spring 19 arranged in the control member 2 returns to its resting shape, causing an axial displacement of the control member 2 which brings about the extraction of the actuating part 9b of the drive element 8 from this passage zone 24a, 24b and which automatically places this control member 2 in the first control position.

It should also be noted that in this description “substantially perpendicular” or “substantially perpendicularly” is understood to mean “strictly perpendicular” or “appreciably perpendicular”.

The invention has been described above by way of example only. It goes without saying that modifications could be made while still remaining within the scope of the claimed invention. By way of example, it is understood that the operating device 1 can be configured to implement more than the four functions described here in this embodiment, in particular by including a casing ring 29 whose through-hole 12 comprises more than two zones for passing the actuating part 9b of the drive element 8 of the control member 2.

### NOMENCLATURE

1. Operating device
2. Control member
3. Support piece
4. Operating member
5. Watch case
6. Middle
7. Grasping element of the control member
8. Drive element
9a. Fastening part
9b. Actuating part
9c. Coupling element of the actuating part
10. Ring
11. Cooperation zone
12. Through-hole
13. Coupling element of the ring
14. Pivoting element
15a. Outer peripheral wall
15b. Inner peripheral wall
16 Shoulder included on the outer surface of the drive element
17. Through-opening
18. First resilient return element
19. Spring
20. Compression piece
21. Rod
22. Shoulder formed on the compression piece
23a. Main portion of the actuating part
23b. Terminal portion of the actuating part
24a. First passage zone
24b. Second passage zone
25a. Eccentric part of the first passage zone
25b. Eccentric part of the second passage zone
26. Central part common to the first and second passage zones
27. Region of the through-opening arranged in the vicinity of the pivoting
element
28. Stop elements of the cooperation zone
29. Casing ring
30. Actuating element of the ring
31. Transmission member
32. Outer surface of the middle
33. Drive zone included in the transmission member
34. Drive zone included in the drive element

1. An operating device (1) for a watch comprising a control member (2) mounted movably in a support piece (3) of this device (1), said piece (2) being intended to be unmoving relative to the horological movement of the watch, said control member (2) comprising a gripping element (7), a drive element (8) mounted such that it is rigidly connected to said gripping element (7) and a transmission member (31) capable of being rotated by said drive element (8), said transmission member (31) being configured to cooperate with a member for actuating a manual winding mechanism of the device (1), capable of storing mechanical energy, in order to operate a first function of the watch, and with a hand-setting member of the device (1) in order to control a second function of the watch, and said drive element (8) being configured to cooperate with an operating member (4) of said device (1) in order to operate third and fourth functions of the watch.

2. The device (1) according to claim 1, wherein the control member (2) is configured to be displaced axially relative to its longitudinal axis (A) between first, second and third control positions for carrying out the first, second, third and fourth functions of the watch.

3. The device (1) according to claim 1, wherein the control member (2) is placed in a first control position in which a mechanical link is established between one end of the transmission member (31) and the actuating member for transmitting, to said actuating member, a rotational motion of the control member (2) in order to implement the first function of the watch.

4. The device (1) according to claim 1, wherein the control member (2) is placed in a second control position in which a mechanical link is established between one end of the transmission member (31) and the hand-setting member for transmitting, to said hand-setting member, a rotational motion of the control member (2) in order to implement the second function of the watch.

5. The device (1) according to claim 1, wherein the control member (2) is configured to be displaced axially relative to its longitudinal axis (A) between first, second and third control positions for carrying out the first, second, third and fourth functions of the watch and when the control member (2) being placed in the first and second control positions, drive zones (33, 34) of the drive element (8) and of the transmission member (31) respectively are joined together to transmit a rotational motion from the gripping element (7) to the transmission member (31).

6. The device (1) according to claim 1, wherein the control member (2) is placed in a third control position in which a mechanical link is established between a free end of the drive element (8) of the control member (2) and a ring (10) movably mounted in a casing ring (29) of the operating member (4) of said device (1), for transmitting, to said ring (10), a rotational motion of the control member (2) in order to implement the third or fourth function of the watch.

7. The device (1) according to claim 1, wherein the control member (2) is placed in a third control position in which a mechanical link is established between a free end of the drive element (8) of the control member (2) and a ring (10) movably mounted in a casing ring (29) of the operating member (4) of said device (1), for transmitting, to said ring (10), a rotational motion of the control member (2) in order to implement the third or fourth function of the watch and when the control member (2) being placed in the third control position, drive zones (33, 34) of the drive element (8) and of the transmission member (31) respectively are separate from each other to transmit a rotational motion from the gripping element (7) to the transmission member (31).

8. The device (1) according to claim 1, wherein the control member (2) is placed in a third control position in which a mechanical link is established between a free end of the drive element (8) of the control member (2) and a ring (10) movably mounted in a casing ring (29) of the operating member (4) of said device (1), for transmitting, to said ring (10), a rotational motion of the control member (2) in order to implement the third or fourth function of the watch and the ring (10) of the control member (4) being configured to actuate mechanisms of a horological movement of the watch implementing said third and fourth functions.

9. The device (1) according to claim 1, wherein the control member (2) is placed in a third control position in which a mechanical link is established between a free end of the drive element (8) of the control member (2) and a ring (10) movably mounted in a casing ring (29) of the operating member (4) of said device (1), for transmitting, to said ring (10), a rotational motion of the control member (2) in order to implement the third or fourth function of the watch and the casing ring (29) comprising, on its inner peripheral wall (15b), a cooperation zone (11) for cooperation between the ring (10) and the free end of the drive element (8), said zone (11) comprising stop elements (28) defining a course of travel of this ring (10) mounted movably in the casing ring (29).

10. The device (1) according to claim 1, wherein the control member (2) is placed in a third control position in which a mechanical link is established between a free end of the drive element (8) of the control member (2) and a ring (10) movably mounted in a casing ring (29) of the operating member (4) of said device (1), for transmitting, to said ring (10), a rotational motion of the control member (2) in order to implement the third or fourth function of the watch and the casing ring (29) comprising a through-hole (12) connecting together inner and outer peripheral walls (15a, 15b) of said casing ring (29), the hole (12) including a zone (24a, 24b) for passing an actuating part (9b) of the drive element (8).

11. The device (1) according to claim 1, wherein the control member (2) is placed in a third control position in which a mechanical link is established between a free end of the drive element (8) of the control member (2) and a ring (10) movably mounted in a casing ring (29) of the operating member (4) of said device (1), for transmitting, to said ring (10), a rotational motion of the control member (2) in order to implement the third or fourth function of the watch and the passage zone (24a, 24b) comprising a central part (26) configured for the arrangement of a main portion (23a) of an actuating part (9b) of the drive element (8) in said hole (12) and an eccentric part (25a, 25b) forming a passage allowing a coupling element (9c) of this actuating part (9b) to pass through the body of said casing ring (29).

12. The device (1) according to claim 1, wherein the control member (2) is placed in a third control position in which a mechanical link is established between a free end of the drive element (8) of the control member (2) and a ring (10) movably mounted in a casing ring (29) of the operating member (4) of said device (1), for transmitting, to said ring (10), a rotational motion of the control member (2) in order to implement the third or fourth function of the watch and the ring (10) comprising an element (30) for actuating a pivoting element (14) of the control member (4) configured to actuate the mechanism implementing the third or fourth function of the watch.

13. The device (1) according to claim 1, wherein the control member (2) is placed in a third control position in which a mechanical link is established between a free end of the drive element (8) of the control member (2) and a ring (10) movably mounted in a casing ring (29) of the operating member (4) of said device (1), for transmitting, to said ring (10), a rotational motion of the control member (2) in order to implement the third or fourth function of the watch and the control member (4) comprising a first resilient return element (18) configured to automatically return the ring (10) to a rest position.

14. The device (1) according to claim 1, wherein the first control position is between the second and third positions.

15. The device (1) according to claim 1, wherein the control member (2) is placed in a third control position in which a mechanical link is established between a free end of the drive element (8) of the control member (2) and a ring (10) movably mounted in a casing ring (29) of the operating member (4) of said device (1), for transmitting, to said ring (10), a rotational motion of the control member (2) in order to implement the third or fourth function of the watch and the drive zone (33) being formed on an inner surface of the drive element (8) and the drive zone (34) is formed on an outer surface of the transmission member (31).

16. A watch comprising the operating device (1) according to claim 1.
